(19) United States
(12) Patent Application Publication
(10) Pub. No.: US 2015/0227074 A1
(43) Pub. Date: Aug. 13, 2015

(54) CONDUCTIVE COMPOSITION FOR ELECTROPHOTOGRAPHIC APPARATUS AND CONDUCTIVE ROLL FOR ELECTROPHOTOGRAPHIC APPARATUSES USING THE SAME

(71) Applicant: SUMITOMO RIKO COMPANY LIMITED, Komaki-shi (JP)

(72) Inventors: Kunio Ito, Komaki-shi (JP); Motoharu Ishihara, Komaki-shi (JP); Kazunori Tooyama, Komaki-shi (JP)

(73) Assignee: SUMITOMO RIKO COMPANY LIMITED, Komaki-shi (JP)

(21) Appl. No.: 14/694,491

(22) Filed: Apr. 23, 2015

Related U.S. Application Data
(63) Continuation of application No. PCT/JP2014/058317, filed on Mar. 25, 2014.

(30) Foreign Application Priority Data
Mar. 29, 2013 (JP) 2013-061430
Dec. 25, 2013 (JP) 2013-266280

(51) Int. Cl. H01B 1/12; H01B 1/02; H01B 1/00; G03G 15/02; B05C 1/08

(52) U.S. Cl. CPC G03G 15/0233; H01B 1/20; H01B 1/22

(57) ABSTRACT

Provided is a conductive composition for use in an electrophotographic apparatus and a conductive roll for use in an electrophotographic apparatus in which resistance reduction can be achieved even when an ion conductive agent is used.

A conductive roll 1 includes a shaft 2, and a base layer 3, a surface layer 4, and an intermediate layer 5 that are formed around the shaft 2 and at least one of which contains a conductive composition containing a polar polymer and a conductivity imparting agent that is quaternary ammonium salt represented by the following formula 1:

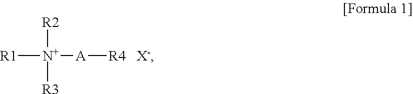

wherein R1 to R3 represent C₁ to C₁₄ alkyl groups, R4 represents one of a methacrylate group and an acrylate group, an anion represented by X⁻ is any one of bistrifluoromethanesulfonimide, triflate, and fluorosulfonylimide, and A represents an alkylene group.

### TECHNICAL FIELD

The present invention relates to conductive compositions for use in electrophotographic apparatuses such as a copying machine, a printer, and a facsimile machine, and to conductive rolls for use in electrophotographic apparatuses using the same.

### BACKGROUND ART

In recent years, electrophotographic apparatuses using an electrophotographic system such as a copying machine, a printer, and a facsimile machine are widely used. In general, a photosensitive drum is incorporated in an electrophotographic apparatus, and a variety of elastic rolls such as a charging roll, a developing roll, a transfer roll, and a toner supply roll are provided around the photosensitive drum.

In general, a conductive roll for an electrophotographic apparatus includes a shaft and a conductive rubber elastic layer formed on the outer periphery of the shaft. Further, an intermediate layer such as a resistance adjusting layer, a surface layer, or the like is sometimes formed on the outer periphery of the rubber elastic layer as necessary.

An elastic roll including a urethane foam layer as an elastic layer is known as a toner supply roll (e.g., see PTL 1). In electrophotographic apparatuses using a one-component developing method instead of a two-component developing method as a printer method, toner conveying performance and a toner charging property are likely to be decreased. The toner supply roll uses a conductive foam in the elastic layer (base layer) in order to improve a toner charging property and toner conveying performance, and is used by supplementarily placing a voltage on the conductive foam.

Examples of conventional means for imparting conductivity to a toner supply roll include (1) means for kneading carbon black in a base layer, (2) means for adding an ion conductive material (ion conductive agent) in a base layer, (3) means for using both of the carbon black and the ion conductive agent in combination, and (4) means for coating a surface with a conductive paint to form a surface layer. For Example, conductive rolls to which generally-used quaternary ammonium salt, quaternary phosphonium salt, or the like is added are known as the conductive roll using the ion conductive agent (e.g., see PTL 2).

### CITATION LIST

### Patent Literature

PTL 1: Japanese Unexamined Patent Application Publication No. Patent JP 2011-112954
PTL 2: Japanese Unexamined Patent Application Publication No. Patent JP 2012-8321

### SUMMARY OF INVENTION

### Problem that the Invention is to Solve

The above-described means (1) to (3) for imparting conductivity to elastic rolls has advantages and disadvantages. For example, while in the means for kneading the carbon black, resistance reduction can be achieved, there arise problems in that the viscosity is increased to result in low productivity, and cell roughening is likely to be made. In addition, while in the means (4) for coating of the conductive paint, resistance reduction can be achieved, there arise problems in that the process for production could be increased, and the coat could peel off. In addition, while in the means for adding the ion conductive agent, variation in the resistance is small, there arise problems in that resistance reduction is difficult to achieve, and electrical resistance is likely to be increased.

The reason why resistance reduction is difficult to achieve in the means for adding the ion conductive agent is as follows. In the ion conductive agent, ions are dissociated to move independently, and thereby the conductive property is demonstrated. However, the ion travel rate is limited in polymer, resistance reduction is difficult to achieve. Even if the additive amount of the ion conductive agent is increased, the resistance values do not increase from a constant value. For this reason, it is assumed that the increased ions hinder their movement each other physically and electrically, which results in no change in ion travel rate, and thereby the resistance is not reduced. In addition, the ion radius is larger than an electron radius in the ion conductive agent, so that the travel rate is slow.

The present invention is made in view of the problems described above, and an object of the present invention is to provide a conductive composition for use in an electrophotographic apparatus and a conductive roll for use in an electrophotographic apparatus in which resistance reduction can be achieved even when an ion conductive agent is used.

### Means for Solving the Problem

To achieve the objects and in accordance with the purpose of the present invention, a conductive composition contains a polar polymer that is used for a constituent material for a conductive member for an electrophotographic apparatus, the composition containing a conductivity imparting agent that is quaternary ammonium salt represented by the following formula 1:

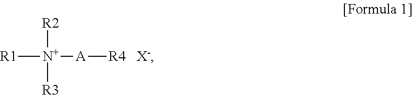

wherein R1 to R3 represent C₁ to C₁₄ alkyl groups, R4 represents one of a methacrylate group and an acrylate group, an anion represented by X⁻ is any one of bistrifluoromethanesulfonimide, triflate, and fluorosulfonylimide, and A represents an alkylene group.

It is preferable that in the conductive composition, the conductivity imparting agent should further contain metallic salt represented by the following formula 2:

M⁺X⁻, [Formula 2]

wherein the metal represented by M is at least one kind of metal selected from the group consisting of sodium, lithium, and potassium, and the anion represented by X⁻ is at least one kind selected from the group consisting of bistrifluoromethanesulfonimide, fluorosulfonylimide, and a perchlorate ion.

It is preferable that in the conductive composition, the polar polymer should be a urethane foam composition containing polyol and polyisocyanate.

It is preferable that in the conductive composition, the polar polymer is at least one kind selected from the group consisting of polyurethane rubber, hydrin rubber, acrylonitrile-butadiene rubber, and polyamide.

In another aspect of the present invention, a conductive roll for use in an electrophotographic apparatus according to the present invention includes a shaft and an elastic layer formed on an outer periphery of the shaft, wherein the elastic layer is made of the above-described conductive composition.

Yet, in another aspect of the present invention, a conductive roll for use in an electrophotographic apparatus according to the present invention includes a shaft, an elastic layer formed on an outer periphery of the shaft, and a surface layer formed on an outermost layer of an outer periphery of the elastic layer, wherein the surface layer is made of the above-described conductive composition.

Yet, in another aspect of the present invention, a conductive roll for use in an electrophotographic apparatus according to the present invention includes a shaft, an elastic layer formed on an outer periphery of the shaft, a surface layer formed on an outermost layer of an outer periphery of the elastic layer, and an intermediate layer between the elastic layer and the surface layer, wherein the intermediate layer is made of the above-described conductive composition.

### Advantage of the Invention

According to the present invention, it is possible to provide a conductive composition for use in an electrophotographic apparatus and a conductive roll for use in an electrophotographic apparatus that are capable of achieving resistance reduction even if the ion conductive agent because the quaternary ammonium salt represented by the above-described [Formula 1] is contained as the conductivity imparting agent. It is assumed that the above-described specific ion conductive agent can exert the effect of resistance reduction because the electrons in cation molecules can be easily biased (separated) to increase the cation performance of nitrogen atoms of the ammonium.

Because the resistance reduction of the ion conductive agent can be achieved, the additive amount of the ion conductive agent can be reduced, which can reduce the amount of the ion conductive agent oozing from a base material.

Because the ion conductive agent is the quaternary ammonium salt, it is expected that a promotional effect should be exerted on the hardenability of the urethane reaction, which could reduce a catalyst amount.

### BRIEF DESCRIPTION OF DRAWINGS

FIG. 1 is a perspective view of the exterior appearance of a conductive roll for use in an electrophotographic apparatus containing the conductive composition according to the present invention;

FIG. 2 is a cross-sectional view of the conductive roll for use in an electrophotographic apparatus taken along the line A-A of FIG. 1; and

FIG. 3 is a cross-sectional view of a conductive roll for use in an electrophotographic apparatus according to another embodiment of the present invention.

### MODE FOR CARRYING OUT THE INVENTION

Hereinafter, a detailed description of the present invention will be provided. The conductive composition according to the present invention is used for a constituent material for a conductive member for an electrophotographic apparatus. Examples of the conductive member include a variety of conductive elastic rolls such as a charging roll, a developing roll, a transfer roll, and a toner supply roll.

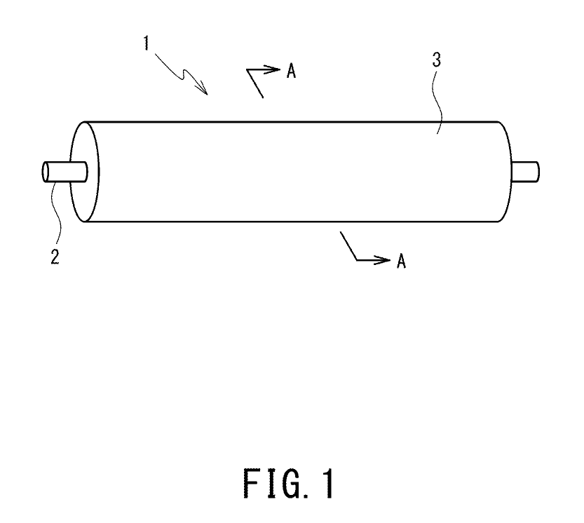

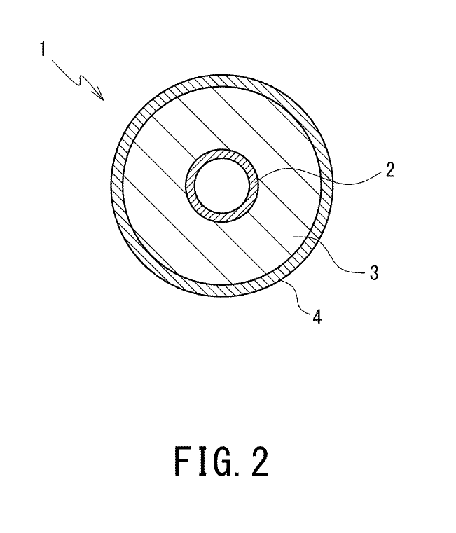

FIG. 1 is a perspective view of the exterior appearance of a conductive roll for use in an electrophotographic apparatus (hereinafter, referred to also as the conductive roll) containing the conductive composition according to one embodiment of the present invention. FIG. 2 is a cross-sectional view taken along the line A-A of FIG. 1. As shown in FIGS. 1 and 2, a conductive roll 1 includes a shaft 2 and a base layer 3 formed on the outer periphery of the shaft 2. The conductive roll 1 further includes a surface layer 4 formed on an outermost layer that defines an outer periphery of the base layer 3 (the surface layer 4 is not illustrated in FIG. 1).

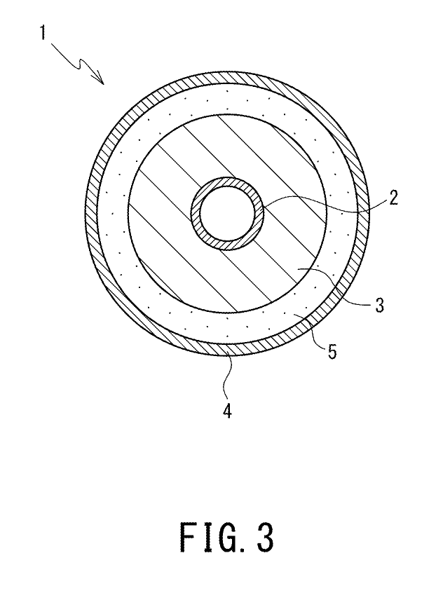

FIG. 3 is a cross-sectional view of the conductive roll according to another embodiment of the present invention. The conductive roll 1 may include an intermediate layer 5 formed on the outer periphery of the base layer 3 between the base layer 3 and the surface layer 4 as shown in FIG. 3. Each of the base layer 3, the surface layer 4, and the intermediate layer 5 may be a single layer or may be a laminated body consisting of a plurality of layers. The conductive roll 1 may include only the base layer 3 on the outer periphery of the shaft 2, which is not illustrated especially.

In the conductive roll 1, at least one of the above-described base layer 3, surface layer 4, and intermediate layer 5 is made of the above-described conductive composition containing a specific ion conductive agent that defines a conductivity imparting agent, and thus the conductive roll 1 has ion conductivity. In addition, in the conductive roll 1, two or more layers among the layers may be made of the above-described conductive composition. Hereinafter, a description of the conductive composition will be provided.

The conductive composition is characterized as containing quaternary ammonium salt represented by the following [Formula 1] as an ion conductive agent that defines a conductivity imparting agent.

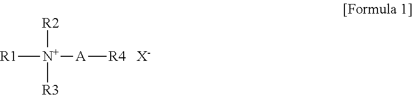

In the above-described [Formula 1], R1 to R3 represent C₁ to C₁₄ alkyl groups. R1 to R3 may be the same alkyl group, or may be different alkyl groups. R1 to R3 are preferably methyl groups. R4 represents an acrylate group or a methacrylate group. A represents a C₁ to C₁₀ alkylene group. For example, —C₂H₄—, and —C₃H₆— are preferably used.

In the above-described [Formula 1], the anion represented by X⁻ is any one of bistrifluoromethanesulfonimide (TFSI), triflate (TF), and fluorosulfonylimide (FSI). TFSI is preferably used as X⁻.

Specific examples of the ion conductive agent represented by the above-described [Formula 1] include ion conductive agents A to D presented in Table 1.

TABLE 1

| Name | Cation | Anion |
|---|---|---|
| Ion conductive agent A | 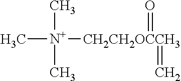 | 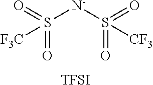 |
| Ion conductive agent B | 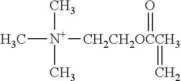 | 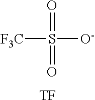 |
| Ion conductive agent C | 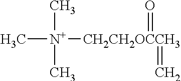 | 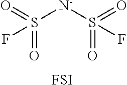 |
| Ion conductive agent D | 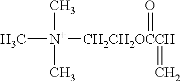 | 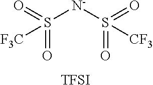 |

In addition to the ion conductive agents represented by [Formula 1], another ion conductive agent may be used in combination as the conductivity imparting agent of the conductive composition. The another ion conductive agent is not limited as far as it can be used in the field of electrophotographic apparatuses. Preferable examples of the another ion conductive agent include lithium salt, quaternary ammonium salt such as trimethyl octadecyl ammonium perchlorate and benzyl trimethyl ammonium chloride, quaternary phosphonium salt, perchlorate such as lithium perchlorate and potassium perchlorate, borate, and an interfacial active agent. One kind of the ion conductive agent may be used alone, or two or more kinds of the ion conductive agents may be used in combination.

The another ion conductive agent is preferably the metallic salt represented by [Formula 2]. In particular, salt of lithium cation and salt of TFSI anion are preferably used.

M⁺X⁻ [Formula 2]

In [Formula 2], the metal represented by M is at least one kind of metal selected from the group consisting of sodium, lithium, and potassium, and the anion represented by X⁻ is at least one kind selected from the group consisting of bistrifluoromethanesulfonimide, fluorosulfonylimide, and a perchlorate ion. Examples of the ion conductive agent represented by [Formula 2] include the ion conductive agents E to H presented in Table 2.

TABLE 2

| Name | Cation | Anion |
|---|---|---|
| Ion conductive agent E | Li⁺ | 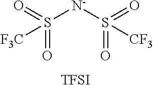 |
| Ion conductive agent F | Li⁺ | 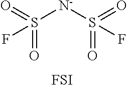 |
| Ion conductive agent G | K⁺ | 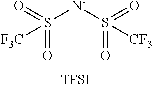 |
| Ion conductive agent H | K⁺ | 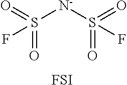 |

The additive amount of the ion conductive agent represented by [Formula 2] is not limited specifically; however, when in using the ion conductive agent represented by [Formula 2] and the ion conductive agent represented by [Formula 1] in combination, it is preferable that the additive amount of the ion conductive agent represented by [Formula 2] should be in the range of 98 mass % or less with respect to the total amount of the ion conductive agent represented by [Formula 1] and the ion conductive agent represented by [Formula 2].

An ion conductive agent other than the ion conductive agent represented by [Formula 1] and the ion conductive agent represented by [Formula 2] may be added to the conductive composition.

In addition, an electronic conductive agent may be added as the conductivity imparting agent. Examples of the electronic conductive agent include carbon black, graphite, a conductive metallic oxide such as a conductive titanium oxide, a conductive zinc oxide, and a conductive tin oxide.

The content of the ion conductive agent in the conductive composition is preferably within the range of 0.1 to 10 parts (hereinafter, all of these units mean parts by mass) with respect to 100 parts of the polar polymer from the viewpoint of resistance reduction.

The polar polymer contained in the conductive composition can be selected as appropriate depending on the intended use or the like of the conductive member made of the conductive composition. When the conductive composition is used in the formation of a foam layer, a conductive foam composition such as a urethane foam composition can be used as the polar polymer. When the conductive composition is used in the formation of a conductive elastic layer made of a non-foamed body, a rubber ingredient such as polyurethane rubber, hydrin rubber, and acrylonitrile-butadiene rubber can be used as the polar polymer. The composition is formed as a conductive rubber composition. When the conductive composition is used in the formation of a coat of the surface layer, a resin ingredient such as polyurethane and polyamide can be used as the polar polymer. The composition is formed as a conductive coat composition.

For example, the above-described urethane foam composition can be made from the following ingredients:

(A) Polyol,

(B) Foam stabilizer,

(C) Water (foaming agent),

(D) Catalyst, and

(E) Isocyanate curing agent.

Examples of the above-described ingredient (A) include polyether polyol such as polypropylene glycol containing no ethylene oxide (EO) (EO-unmodified PPG), EO-modified polypropylene glycol (EO-modified PPG), and polyethylene glycol, polyester polyol, polybutadiene polyol, polyisobutylene polyol, and polytetramethylene glycol. One kind of the polyol may be used alone, or two or more kinds of the polyols may be used in combination.

The EO-unmodified PPG and the EO-modified PPG have a number average molecular mass (Mn) preferably within the range of 1,000 to 10,000, and more preferably within the range of 2,000 to 8,000.

Examples of the above-described ingredient (B) include silicone foam stabilizer as the foam stabilizer. Examples of the silicone foam stabilizer include a polyoxyalkylene-dimethylpolysiloxane copolymer and polydimethylsiloxane. One kind of the silicone foam stabilizer may be used alone, or two or more kinds of the silicone foam stabilizers may be used in combination. The content of the silicone foam stabilizer is preferably within the range of 0.1 to 10 parts (hereinafter, all of these units mean parts by mass) and more preferably within the range of 0.2 to 5 parts with respect to 100 parts of the ingredient (A).

The content of the above-described ingredient (C), water, is preferably within the range of 0.1 to 10 parts and more preferably within the range of 0.5 to 5.0 parts with respect to 100 parts of the ingredient (A).

As the above-described ingredient (D), for example, an amine catalyst is used. Examples of the amine catalyst include a tertiary amine catalyst such as triethylenediamine (TEDA), dimethylaminoethyl morpholine, triethylamine, N,N-dimethylcyclohexylamine, N,N,N′,N′-tetramethylethylenediamine (TMEDA), N,N,N′,N″,N″-pentamethyldiethylenetriamine (PMDETA), dimethylamino ethanol (DMEA), and bis(2-dimethylaminoethyl) ether (BDMEE). One kind of the amine catalyst may be used alone, or two or more kinds of the amine catalysts may be used in combination. Among the above-described amine catalysts, the triethylenediamine (TEDA) and the dimethylaminoethyl morpholine are preferably used from the viewpoint of curability. The content of the amine catalyst is preferably within the range of 0.1 to 10 parts and more preferably within the range of 0.5 to 5 parts with respect to 100 parts of the ingredient (A).

Examples of the above-described ingredient (E) include toluene diisocyanate (TDI), 4,4′-diphenylmethane diisocyanate (MDI), polymeric isocyanate (Cr-MDI), ortho-toluidine diisocyanate (TODI), naphthylene diisocyanate (NDI), xylylene diisocyanate (XDI), and carbodiimide modified MDI. One kind of the isocyanate curing agent may be used alone, or two or more kinds of the isocyanate curing agents may be used in combination.

In addition to the above-described ingredients, the urethane foam composition may contain an interconnecting agent (foam breaker), a crosslinking agent, an interfacial active agent, a flame retardant, a filler, an antistatic agent, and a reaction inhibitor as appropriate. One kind of the agent may be used alone, or two or more kinds of the agents may be used in combination.

A prepolymer may be used for the urethane foam composition. The composition may be produced by preparing a reaction product of the above-described ingredient (A) and ingredient (E) as a prepolymer, preparing a preliminary mixture that is obtained by preliminarily mixing the ingredients except the prepolymer at a predetermined rate, and mixing the prepolymer and the preliminary mixture in a predetermined range.

Examples of the polyurethane rubber as the above-described conductive rubber composition include thermoplastic polyurethane.

Examples of the hydrin rubber as the above-described conductive rubber composition include an epichlorohydrin homopolymer (CO), an epichlorohydrin-ethylene oxide binary copolymer (ECO), an epichlorohydrin-allyl glycidyl ether binary copolymer (GCO), and an epichlorohydrin-ethylene oxide-allyl glycidyl ether ternary copolymer (GECO).

Examples of the acrylonitrile-butadiene rubber as the above-described conductive rubber composition include nitrile rubber (NBR).

In addition to the above-described rubber ingredient and the above-described ion conductive agent represented by [Formula 1], the conductive rubber composition may contain a filler such as carbon black, silica, and a metal oxide, a crosslinking agent such as a sulfur and peroxide, a reaction accelerator, an antiscorching agent, an anti-aging agent, a plasticizing agent, a lubricant, and a foaming agent as appropriate.

Examples of the polyurethane as the above-described conductive coat composition include thermoplastic polyurethane.

Examples of the polyamide as the above-described conductive coat composition include N-methoxymethyl nylon.

In addition to the above-described resin ingredient and the above-described ion conductive agent represented by [Formula 1], the conductive coat composition may contain a solvent, a catalyst, and a crosslinking agent as appropriate.

Hereinafter, a description of the other constituent members of the conductive roll will be provided. The shaft 2 is not specifically limited as long as it has conductivity. Specific examples of the shaft 2 include a core bar of a solid body or a hollow body made of metal such as iron, stainless steel, and aluminum. An adhesive, a primer, or the like may be applied on the surface of the shaft body 2 as necessary. Conductivity may be imparted to the adhesive, the primer, or the like as necessary.

The base layer 3 is formed as an elastic layer. The elastic layer may be a non-foamed layer or a foamed layer. Specific examples of the elastic layer include a foamed layer such as a urethane foam, and a rubber elastic layer. In imparting conductivity to the base layer 3 to form a conductive elastic layer, the conductive foamed layer or the conductive rubber layer containing the above-described ion conductive agent represented by [Formula 1] is used.

The volume resistivity of the conductive elastic layer is adjusted so as to be a desired volume resistivity according to the intended use. To be specific, it is preferable that the volume resistivity should be in the range of 1×10³ to 1×10¹⁰ Ω·cm.

The base layer 3 may contain one kind or two or more kinds of additives such as a lubricant, an anti-aging agent, a light stabilizer, a viscosity modifier, a processing aid, a flame retardant, a foaming agent, a filler, a dispersing agent, a de foaming agent, a pigment, a mold-release agent, and a vulcanizing agent as necessary.

The base layer 3 can be formed using a method such that the shaft 2 is coaxially set in the hollow portion of a roll forming mold, and the composition for a conductive elastic layer is injected into the mold and heated/cured (vulcanized) to be released from the mold (injection method), a method such that the conductive rubber composition is extrusion molded on the surface of the shaft 2 (extrusion method), or the like. The thickness of the base layer 3 is set to be about 0.1 to 10 mm.

The surface layer 4 is capable of imparting surface protection performance, low frictional properties, releasability, charging ability, and the like to the surface of the conductive roll 1.

The main ingredient from which the surface layer 4 is made is not limited specifically, and examples of the main ingredient include a polyamide (nylon) polymer, an acrylic polymer, a urethane polymer, a silicone polymer, and a fluorine polymer. These polymers may be modified. Examples of the modifying group include an N-methoxymethyl group, a silicone group, a fluorine group.

In imparting conductivity to the surface layer 4, the conductive coat composition containing the above-described ion conductive agent represented by [Formula 1] is used to form the surface layer 4. In addition to the above-described ion conductive agent, carbon black, graphite, c-TiO₂, c-ZnO, c-SnO₂ (c- means conductivity), and other ion conductive agents can be added as appropriate. In addition, other additives may be added as appropriate to the conductive coat composition if necessary. Examples of the other additives include a lubricant, a vulcanization accelerator, an ultraviolet curing catalyst, an anti-aging agent, a light stabilizer, a viscosity modifier, a processing aid, a flame retardant, a plasticizing agent, a foaming agent, a filler, a dispersing agent, a defoaming agent, a pigment, and a mold-release agent.

From the viewpoint of adjusting the viscosity, the conductive coat composition may contain an organic solvent such as methyl ethyl ketone, toluene, acetone, ethyl acetate, butyl acetate, methyl isobutyl ketone (MIBK), THF, and DMF, and a water-soluble solvent such as methanol and ethanol as appropriate.

The surface layer 4 can be formed on the outermost surface of the outer periphery of the conductive elastic layer (the base layer 2) by a method of coating the composition for the surface layer 4 or the like. As the coating method, a variety of coating methods such as a roll coating method, a dipping method, and a spray coating method can be used. The coated surface layer may be subjected to ultraviolet irradiation or a heat treatment as necessary.

The thickness of the surface layer 4 is generally set to be about 0.01 to 100 μm. The volume resistivity of the surface layer 4 is generally set to be 10⁴ to 10¹⁰ Ω·cm, and preferably 10⁶ to 10⁸ Ω·cm.

The intermediate layer 5 can be formed as a resistance adjusting layer for adjusting the resistance of the entire conductive roll 1. When made of a conductive layer containing the ion conductive agent represented by [Formula 1], the intermediate layer 5 can be made from the composition same as the composition for the surface layer 4 to which the above-described conductivity imparting agent is added.

The intermediate layer 5 can be formed in a method of coating the composition for the intermediate layer 5 on the surface of the base layer 2 or the like. As the coating method, the same method as the coating method for the surface layer 4 can be used.

The thickness of the intermediate layer 5 is generally set to be about 0.01 to 100 μm. The volume resistivity of the intermediate layer 5 is generally set to be about 10⁴ to 10¹⁰ Ω·cm, and preferably 10⁶ to 10⁸ Ω·cm.

### EXAMPLES

A description of the present invention will now be provided with reference to Examples and Comparative Examples. The ion conductive agents used in Examples and Comparative Examples are as follows.

### [Ion Conductive Agents]

The ion conductive agents A to D presented in Table 1 were used as the ammonium salt represented by the above-described [Formula 1]. The ion conductive agents E to H presented in Table 2 were used as the ion conductive agent represented by the above-described [Formula 2]. In addition, the ion conductive agents I to J presented in Table 3 were used as the ion conductive agents other than the ion conductive agents represented by the above-described [Formula 1] and [Formula 2].

TABLE 8

| Name | Cation | Anion |
|---|---|---|
| Ion conductive agent I | 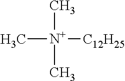 | [ClO₄]⁻ |
| Ion conductive agent J | 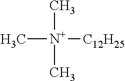 | 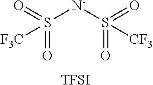 |

### Examples 1-1 to 1-14 and Comparative Examples 1-1 to 1-4

### Toner Supply Rolls

The materials were prepared so as to be the ratios (unit: part by mass) presented in Tables 4 to 6, and mixed with the use of an agitator, and thus the urethane foam compositions according to Examples and Comparative Examples were prepared. Detailed descriptions of the materials presented in Tables 4 to 6 will be provided below.

[Raw Materials for Urethane Foams]

(Polyether Polyol)
Manuf.: SANYO CHEMICAL INDUSTRIES, LTD., product name: “SANNIX FA703”, EO content rate: 10%, OHv: 33 mgKOH/g
Manuf.: ASAHI GLASS CO., LTD. product name: “EXCENOL3021”, EO content rate: 0%, OHv: 34 mgKOH/g

(Silicone Foam Stabilizer)
Manuf.: TORAY DOW CORNING CO., LTD., product name: “SRX274DL”

(Foaming Agent)
Distilled water: OHv: 6233 mgKOH/g

(Ion Conductive Agent): See Tables 1 to 3

(Catalyst)
Manuf.: TOSOH CORPORATION, product name: “TEDA L33”
Manuf.: TOSOH CORPORATION, product name: “TOYOCAT ET”

(Polyisocyanate)
Toluene diisocyanate (TDI): Manuf.: NIPPON POLYURETHANE INDUSTRY CO., LTD., product name: “CORONATE T80”, NCO content (48% by mass)
Polymeric isocyanate: Manuf.: NIPPON POLYURETHANE INDUSTRY CO., LTD., product name: “MILLIONATE MR200”, NCO content (31% by mass)

<Preparation of Conductive Rolls>

Core bars (6 mm in diameter) were inserted into the centers of cylindrical molds, and the urethane compositions presented in Tables 4 to 6 were each injected in the molds such that the urethane compositions according to Examples 1-1 to 1-7 and Comparative Examples 1-1 to 1-4 have a foam specific gravity of 0.11 g/cm³ and such that the urethane compositions according to Examples 1-8 to 1-14 have a foam specific gravity of 0.14 g/cm³. Then, the urethane compositions were heated at 90° C. for 30 minutes to be foamed and cured, and released from the molds. Thus, toner supply rolls having a configuration such that a urethane foam layer was formed on the outer periphery of the shaft and having a diameter of 13.2 mm were prepared.

Using the conductive rolls according to Examples 1-1 to 1-14 and Comparative Examples 1-1 to 1-4, resistance measurement was performed, volume resistivities and resistance variation widths after energization endurance were measured, printing tests were performed, and evaluation of the conductive rolls in the early stage and after the endurance was performed. Results thereof are presented in Tables 4 to 6. The test method and the evaluation method are as follows.

(Volume Resistivity)

Resistance measurement of the conductive rolls was performed to obtain resistance values in the early stage. In the measurement, a direct voltage of 200 V was placed on each of the conductive rolls at both the ends from an end portion of the core bar under a load of 500 g in an N/N environment (23° C., RH 50%), and a roll resistance value of one minute at a revolution rate of 30 rpm was measured.

(Energization Durability)

Resistance values after one minute and after 30 minutes were measured under the above-described volume resistivity measurement conditions. The rise widths were regarded as the resistance variation widths, and expressed by the digit numbers of the resistance variation widths. Thus, energization durability was evaluated.

(Printing Evaluation)

Printed images in the early stage for printing evaluation were printed out by installing each of the conductive rolls as a toner supply roll in an apparatus (manuf.: RICOH COMPANY LTD., product name: IPUSIO CX3000), and printing a solid image in an LL environment (15° C., RH 10%). Inconsistencies in density in the printed images were checked. The images having inconsistencies in density were evaluated as poor. The images having no inconsistency in density were evaluated as good.

(Durability Evaluation)

After each of the rolls was subjected to printing of 5000 sheets in the setting of the above-described printing evaluation, solid images were printed. Inconsistencies in density in the solid images were checked in a manner similar to the printing evaluation of the printed images in the early stage. The solid images having inconsistencies in density were evaluated as poor. The images on which toner was not transferred to have white portions on the sheets were evaluated as unusable. The images having no inconsistency in density were evaluated as good. The images having especially uniform density were evaluated as very good.

TABLE 4

| | | | | | Example | | | | | | |
|---|---|---|---|---|---|---|---|---|---|---|---|
| | | Material name | OHV | NCO | 1-1 | 1-2 | 1-3 | 1-4 | 1-5 | 1-6 | 1-7 |
| Material | Polyol | FA703 | 33 | — | 100 | 100 | 100 | 100 | 100 | 100 | — |
| | | EXCENOL3021 | 34 | — | — | — | — | — | — | — | 100 |
| | Foam stabilizer | SRX274DL | — | — | 1 | 1 | 1 | 1 | 1 | 1 | 1 |
| | Foaming agent | Distilled water | 6233 | — | 1.7 | 1.7 | 1.7 | 1.7 | 1.7 | 1.7 | 1.7 |
| | Ion conductive | Ion conductive agent A [Formula 1] | | | 1 | — | — | — | 0.5 | — | — |
| | agent | Ion conductive agent B [Formula 1] | | | — | 1 | — | — | — | — | 1 |
| | | Ion conductive agent C [Formula 1] | | | — | — | 1 | — | — | 1 | — |
| | | Ion conductive agent D [Formula 1] | | | — | — | — | 1 | — | — | — |
| | | Ion conductive agent E [Formula 2] | | | — | — | — | — | 0.5 | — | — |
| | | Ion conductive agent F [Formula 2] | | | — | — | — | — | — | — | — |
| | | Ion conductive agent G [Formula 2] | | | — | — | — | — | — | — | — |
| | | Ion conductive agent H [Formula 2] | | | — | — | — | — | — | — | — |
| | | Ion conductive agent I | | | — | — | — | — | — | — | — |
| | | Ion conductive agent J | | | — | — | — | — | — | — | — |
| | Catalyst | TEDA L33 | | | 0.2 | 0.2 | 0.2 | 0.2 | 0.2 | 0.2 | 0.2 |
| | | TOYOCAT ET | | | 0.05 | 0.05 | 0.05 | 0.05 | 0.05 | 0.05 | 0.05 |
| | OHV [mgKOH/g] | | | | 134 | 134 | 134 | 134 | 134 | 134 | 135 |
| | Isocyanate | CORONATE T80 (TDI) | — | 48% | 15.2 | 15.2 | 15.2 | 15.2 | 15.2 | 21.7 | 21.8 |
| | | MILLIONATE MR200 | — | 31% | 10.1 | 10.1 | 10.1 | 10.1 | 10.1 | — | — |

| | NCO [%] | 41.2 | 41.2 | 41.2 | 41.2 | 41.2 | 48 | 48 |
|---|---|---|---|---|---|---|---|---|
| | NCO/OH-Index | 100 | 100 | 100 | 100 | 100 | 100 | 100 |
| Foam specific gravity [g/cm³] | | 0.11 | 0.11 | 0.11 | 0.11 | 0.11 | 0.11 | 0.11 |
| Roll | Volume resistivity (early stage) [Ω] | 7E6 | 3E7 | 1E7 | 7E6 | 6E6 | 9E6 | 8E7 |
| evaluation | Energization durability | 0.1 | 0.1 | 0.1 | 0.1 | 0.2 | 0.1 | 0.2 |
| | (resistance rise width after energization [digit] | | | | | | | |
| | Printing evaluation (printed image in early stage) | Very | Good | Good | Very | Very | Good | Good |
| | | good | | | good | good | | |
| | Durability evaluation (printed image after endurance) | Very | Good | Good | Very | Very | Good | Good |
| | | good | | | good | good | | |

TABLE 5

| | | | | | Example | | | | | | |
|---|---|---|---|---|---|---|---|---|---|---|---|
| | | Material name | OHV | NCO | 1-8 | 1-9 | 1-10 | 1-11 | 1-12 | 1-13 | 1-14 |
| Material | Polyol | FA703 | 33 | — | 100 | 100 | 100 | 100 | 100 | 100 | 100 |
| | | EXCENOL3021 | 34 | — | — | — | — | — | — | — | — |
| | Foam stabilizer | SRX274DL | — | — | 1 | 1 | 1 | 1 | 1 | 1 | 1 |
| | Foaming agent | Distilled water | 6233 | — | 1.7 | 1.7 | 1.7 | 1.7 | 1.7 | 1.7 | 1.7 |
| | Ion conductive | Ion conductive agent A [Formula 1] | | | 0.9 | 0.1 | 0.02 | — | — | — | — |
| | agent | Ion conductive agent B [Formula 1] | | | — | — | — | — | — | — | 1 |
| | | Ion conductive agent C [Formula 1] | | | — | — | — | — | — | 0.2 | 0.8 |
| | | Ion conductive agent D [Formula 1] | | | — | — | — | 0.2 | 0.8 | — | — |
| | | Ion conductive agent E [Formula 2] | | | 0.1 | 0.9 | 0.98 | — | — | — | — |
| | | Ion conductive agent F [Formula 2] | | | — | — | — | 0.8 | — | 0.8 | — |
| | | Ion conductive agent G [Formula 2] | | | — | — | — | — | 0.2 | — | — |
| | | Ion conductive agent H [Formula 2] | | | — | — | — | — | — | — | 0.2 |
| | | Ion conductive agent I | | | — | — | — | — | — | — | — |
| | | Ion conductive agent J | | | — | — | — | — | — | — | — |
| | Catalyst | TEDA L33 | | | 0.2 | 0.2 | 0.2 | 0.2 | 0.2 | 0.2 | 0.2 |
| | | TOYOCAT ET | | | 0.05 | 0.05 | 0.05 | 0.05 | 0.05 | 0.05 | 0.05 |
| | OHV [mgKOH/g] | | | | 134 | 134 | 134 | 134 | 134 | 134 | 135 |
| | Isocyanate | CORONATE T80 (TDI) | — | 48% | 15.1 | 15.1 | 15.1 | 15.1 | 15.1 | 15.1 | 15.1 |
| | | MILLIONATE MR200 | — | 31% | 10.1 | 10.1 | 10.1 | 10.1 | 10.1 | 10.1 | 10.1 |

| | NCO [%] | 41.2 | 41.2 | 41.2 | 41.2 | 41.2 | 41.2 | 41.2 |
|---|---|---|---|---|---|---|---|---|
| | NCO/OH-Index | 100 | 100 | 100 | 100 | 100 | 100 | 100 |
| Foam specific gravity [g/cm³] | | 0.14 | 0.14 | 0.14 | 0.14 | 0.14 | 0.14 | 0.14 |
| Roll | Volume resistivity (early stage) [Ω] | 4E6 | 3E6 | 3E6 | 3E6 | 4E6 | 4E6 | 4E6 |
| evaluation | Energization durability | 0.1 | 0.3 | 0.4 | 0.3 | 0.1 | 0.3 | 0.1 |
| | (resistance rise width after energization [digit] | | | | | | | |
| | Printing evaluation (printed image in early stage) | Very | Good | Good | Very | Very | Very | Very |
| | | good | | | good | good | good | good |
| | Durability evaluation (printed image after endurance) | Very | Good | Good | Very | Very | Very | Very |
| | | good | | | good | good | good | good |

TABLE 6

| | | | Comparative Example | | | |
|---|---|---|---|---|---|---|
| Material name | OHV | NCO | 1-1 | 1-2 | 1-3 | 1-4 |

| Material | Polyol | FA703 | 33 | — | 100 | 100 | 100 | 100 |
|---|---|---|---|---|---|---|---|---|
| | | EXCENOL3021 | 34 | — | — | — | — | — |
| | Foam stabilizer | SRX274DL | — | — | 1 | 1 | 1 | 1 |
| | Foaming agent | Distilled water | 6233 | — | 1.7 | 1.7 | 1.7 | 1.7 |
| | Ion conductive | Ion conductive agent A [Formula 1] | | | — | — | — | — |
| | agent | Ion conductive agent B [Formula 1] | | | — | — | — | — |
| | | Ion conductive agent C [Formula 1] | | | — | — | — | — |
| | | Ion conductive agent D [Formula 1] | | | — | — | — | — |
| | | Ion conductive agent E [Formula 2] | | | — | — | — | — |
| | | Ion conductive agent F [Formula 2] | | | — | — | — | — |
| | | Ion conductive agent G [Formula 2] | | | — | — | — | — |
| | | Ion conductive agent H [Formula 2] | | | — | — | — | — |
| | | Ion conductive agent I | | | — | 1 | 2 | — |
| | | Ion conductive agent J | | | — | — | — | 1 |
| | Catalyst | TEDA L33 | | | 0.2 | 0.2 | 0.2 | 0.2 |
| | | TOYOCAT ET | | | 0.05 | 0.05 | 0.05 | 0.05 |
| | OHV [mgKOH/g] | | | | 135 | 134 | 132 | 134 |
| | Isocyanate | CORONATE T80 (TDI) | — | 48% | 15.2 | 15.2 | 15.2 | 15.2 |
| | | MILLIONATE MR200 | — | 31% | 10.1 | 10.1 | 10.1 | 10.1 |

| | NCO % | 41.2 | 41.2 | 41.2 | 41.2 |
|---|---|---|---|---|---|
| | NCO/OH-Index | 100 | 100 | 100 | 100 |
| Foam specific gravity [g/cm³] | | 0.11 | 0.11 | 0.11 | 0.11 |
| Roll | Volume resistivity (early stage) [Ω] | 4E10 | 3E8 | 2E8 | 2E8 |
| evaluation | Energization durability | 0.3 | 0.4 | 0.4 | 0.4 |
| | (resistance rise width after energization [digit] | | | | |
| | Printing evaluation (printed image in early stage) | Unusable | Poor | Poor | Poor |
| | Durability evaluation (printed image after endurance) | Unusable | Poor | Poor | Poor |

As shown in Tables 4 and 5, the conductive rolls according to Examples 1-1 to 1-14 had low volume resistivities, and good printing evaluations and good durability evaluations.

Meanwhile, the conductive roll according to Comparative Example 1-1, because not containing the conductive agent, could not obtain a predetermined conductivity and had poor printing evaluation as shown in Table 6. The conductive roll according to Comparative Example 1-2, because containing the ion conductive agent that is the general-purpose quaternary ammonium salt, had a higher volume resistivity and poorer printing evaluation compared with a conductive roll using a composition containing quaternary ammonium salt having the specific structure. The conductive roll according to Comparative Example 1-3, in which the additive amount of the ion conductive agent was increased compared with Comparative Example 1-2, obtained almost the same result as the conductive roll according to Comparative Example 1-2, and the conductivity could not be improved. The conductive roll according to Comparative Example 1-4 could not obtain a good result because while anions same as the conductive rolls according to Example 1-1 or the like were used, the structure of the cations was different from the structure represented by [Formula 1].

### Examples 2-1 to 2-2 and Comparative Example 2-1

### Charging Rolls

The materials were prepared so as to be the ratios (unit: part by mass) presented in Table 7, and mixed with the use of an agitator, and thus the compositions of the base materials and the compositions of the coat materials according to the Examples and Comparative Example were prepared. Detailed descriptions of the materials presented in Table 7 will be provided below.

[Base Materials of Base Layer]
ECO: Manuf.: DAISO CO., LTD., product name: “EPICHLOMER CG102”
Carbon black: Manuf.: TOKAI CARBON CO., LTD., product name: “SEAST 116”
Peroxide: 2,5-dimethyl-2,5-di(t-butyl peroxy) hexane: Manuf.: NOF Corporation, product name: “PERHEXA 25B40”
Ion conductive agent: see Tables 1 and 3

[Coat Materials of Surface Layer]
N-methoxymethylated nylon
Citric acid
Methanol
Ion conductive agent: see Tables 1 and 3

<Preparation of Conductive Rolls>

(Formation of Base Layers)

Core bars (6 mm in diameter) were inserted into the centers of cylindrical molds, and the compositions of the above-described base materials were each injected in the molds. Then, the compositions were heated at 170° C. for 30 minutes, cooled, and released from the molds. Thus, base layers having a thickness of 2 mm were formed on the outer peripheries of the core bars.

(Formation of Surface Layers)

The surfaces of the base layers were roll-coated with the compositions of the above-described coat materials, and heated at 150° C. for 30 minutes. Thus, surface layers having a thickness of 10 μm were formed on the outer peripheries of the base layers. In this manner, charging rolls were prepared.

Using the conductive rolls according to Examples 2-1 to 2-2 and Comparative Example 2-1, resistance measurement was performed, volume resistivities and resistance variation widths after energization endurance were measured, printing tests were performed, and evaluation of the conductive rolls in the early stage and after the endurance was performed. Results thereof are presented in Table 7. The test method and the evaluation method are as follows.

(Volume Resistivities)

The conductive rolls were rotated in a metal drum at 200 rpm, and resistance values under the voltage of 1000 V were measured as roll resistivities.

(Energization Durability)

Resistance values after one minute and after 30 minutes were measured under the above-described volume resistivity measurement conditions. The rise widths were regarded as the resistance variation widths, and expressed by the digit numbers of the resistance variation widths. Thus, energization durability was evaluated.

(Printing Evaluation)

Printed images in the early stage for printing evaluation were printed out by installing each of the conductive rolls as a charging roll in an apparatus (manuf.: RICOH COMPANY LTD., product name: IPUSIO CX3000), and printing a solid image. Inconsistencies in density in the printed images were evaluated visually. The images having inconsistencies in density were evaluated as poor. The images having no inconsistency in density were evaluated as good.

(Durability Evaluation)

After each of the rolls was subjected to printing of 10000 halftone images in the setting of the above-described printing evaluation, solid images were printed. Inconsistencies in density in the solid images were visually evaluated in a manner similar to the printing evaluation of the printed images in the early stage. The solid images having inconsistencies in density were evaluated as poor. The images having no inconsistency in density were evaluated as good.

As shown in Table 7, the conductive rolls according to Examples 2-1 and 2-2 could achieve resistance reduction, had an increased charged-electric quantity, and could obtain good printed images in the early stage. In addition, the conductive rolls according to Examples 2-1 and 2-2 did not have resistance variation caused by energization endurance, so that image deterioration after the endurance was less. Meanwhile, the conductive roll according to Comparative Example 2-1, because not containing the ion conductive agent represented by [Formula 1] in either of the base layer or the surface layer, had large resistance variation caused by energization endurance, so that the printed images both in the early stage and after the endurance were faulty.

TABLE 7

| | | | | | Comparative |
|---|---|---|---|---|---|
| | | | Example | | Example |
| | | Material name | 2-1 | 2-2 | 2-1 |
| Base | ECO | EPICHLOMER CG102 | 100 | 100 | 100 |
| material | Carbon black | SEAST 116 | 1 | 1 | 1 |
| | Peroxide | PERHEXA 25B40 | 1 | 1 | 1 |
| | Ion conductive | Ion conductive agent J | — | 1 | 1 |
| | agent | Ion conductive agent A | 1 | — | — |
| | | [Formula 1] | | | |
| Coat | Nylon coat | N-methoxymethylated nylon | 100 | 100 | 100 |
| Material | | Citric acid | 1 | 1 | 1 |
| | | Methanol | 300 | 300 | 300 |
| | Ion conductive | Ion conductive agent I | 1 | — | 1 |
| | agent | Ion conductive agent A | — | 1 | — |
| | | [Formula 1] | | | |

| | Dispersion method | Sand mill dispersion | | |
|---|---|---|---|---|
| Roll | Volume resistivity (early stage) [Ω] | 2E6 | 4E6 | 2E7 |
| evaluation | Energization durability | 0.1 | 0.2 | 0.6 |
| | (resistance rise width after energization [digit] | | | |
| | Printing evaluation (printed image in early stage) | Good | Good | Poor |
| | Durability evaluation | Good | Good | Poor |
| | (printed image after endurance) | | | |

### Examples 3-1 to 3-2 and Comparative Example 3-1

### Developing Rolls

The materials were prepared so as to be the ratios (unit: part by mass) presented in Table 8, and mixed with the use of an agitator, and thus the compositions of the base materials and the compositions of the coat materials according to the Examples and Comparative Example were prepared. Detailed descriptions of the materials presented in Table 8 will be provided below.

[Base Materials of Base Layer]
NBR: Manuf.: Zeon Corporation, product name: “NIPOL DN202”
Carbon black: Manuf.: TOKAI CARBON CO., LTD., product name: “SEAST 116”
Peroxide: 2,5-dimethyl-2,5-di(t-butyl peroxy) hexane: Manuf.: NOF Corporation, product name: “PERHEXA 25B40”
Ion conductive agent: see Tables 1 and 3

[Coat Materials of Surface Layer]
Polyurethane: Manuf.: NIPPON POLYURETHANE INDUSTRY CO., LTD., product name: “NIPPOLAN 5199”
Organic resin particle: Manuf.: NEGAMI CHEMICAL INDUSTRIAL CO., LTD., product name: “ART-PEARL C400BM”
Solvent: MEK
Ion conductive agent: see Tables 1 and 3

<Preparation of Developing Rolls>

(Formation of Base Layers)

Core bars (6 mm in diameter) were inserted into the centers of cylindrical molds, and the compositions of the above-described base materials were each injected in the molds. Then, the compositions were heated at 170° C. for 30 minutes, cooled, and released from the molds. Thus, base layers having a thickness of 5 mm were formed on the outer peripheries of the core bars.

(Formation of Surface Layers)

The surfaces of the base layers were roll-coated with the compositions of the above-described coat materials, and heated at 160° C. for 30 minutes. Thus, surface layers having a thickness of 10 μm were formed on the outer peripheries of the base layers. In this manner, developing rolls were prepared.

Using the conductive rolls according to Examples 3-1 to 3-2 and Comparative Example 3-1, resistance measurement was performed, volume resistivities and resistance variation widths after energization endurance were measured, printing tests were performed, and evaluation of the conductive rolls in the early stage and after the endurance was performed. Results thereof are presented in Table 8. The test method and the evaluation method are as follows.

(Volume Resistivities)

The conductive rolls were rotated in a metal drum at 200 rpm, and resistance values under the voltage of 1000 V were measured as roll resistivities.

(Energization Durability)

Resistance values after one minute and after 30 minutes were measured under the above-described volume resistivity measurement conditions. The rise widths were regarded as the resistance variation widths, and expressed by the digit numbers of the resistance variation widths. Thus, energization durability was evaluated.

(Printing Evaluation)

Printed images in the early stage for printing evaluation were printed out by installing each of the conductive rolls as a charging roll in an apparatus (manuf.: Canon Inc., product name: LBP2510), and printing a solid image. Inconsistencies in density in the printed images were evaluated visually. The images having inconsistencies in density were evaluated as poor. The images having no inconsistency in density were evaluated as good.

(Durability Evaluation)

After each of the rolls was subjected to printing of 10000 halftone images in the setting of the above-described printing evaluation, solid images were printed. Inconsistencies in density in the solid images were visually evaluated in a manner similar to the printing evaluation of the printed images in the early stage. The solid images having inconsistencies in density were evaluated as poor. The images having no inconsistency in density were evaluated as good.

| | | | | | Comparative |
|---|---|---|---|---|---|
| | | | Example | | Example |
| | | Material name | 3-1 | 3-2 | 3-1 |
| Base | NBR | NIPOL DN202 | 100 | 100 | 100 |
| material | Carbon black | SEAST 116 | 1 | 1 | 1 |
| | Peroxide | PERHEXA 25B40 | 1 | 1 | 1 |
| | Ion conductive | Ion conductive agent I | — | 1 | 1 |
| | agent | Ion conductive agent A | 1 | — | — |
| | | [Formula 1] | | | |
| Coat | Urethane coat | NIPPOLAN 5199 | 100 | 100 | 100 |
| Material | | ART-PEARL C400BM | 15 | 15 | 15 |
| | | MEK | 400 | 400 | 400 |
| | Ion conductive | Ion conductive agent J | 1 | — | 1 |
| | agent | Ion conductive agent A | — | 1 | — |
| | | [Formula 1] | | | |

| | Dispersion method | Sand mill dispersion | | |
|---|---|---|---|---|
| Roll | Volume resistivitv (early stage) [Ω] | 4E7 | 6E7 | 4E8 |
| evaluation | Energization durability | 0.1 | 0.1 | 0.4 |
| | (resistance rise width after energization [digit] | | | |
| | Printing evaluation (printed image in early stage) | Good | Good | Poor |
| | Durability evaluation | Good | Good | Poor |
| | (printed image after endurance) | | | |

As shown in Table 8, the conductive rolls according to Examples 3-1 and 3-2 could achieve resistance reduction, had an increased charged-electric quantity, and could obtain good printed images in the early stage. In addition, the conductive rolls according to Examples 3-1 and 3-2 did not have resistance variation caused by energization endurance, so that image deterioration after the endurance was less. Meanwhile, the conductive roll according to Comparative Example 3-1, because not containing the ion conductive agent represented by [Formula 1] in either of the base layer or the surface layer, had large resistance variation caused by energization endurance, so that the printed images both in the early stage and after the endurance were faulty.

The foregoing description of the preferred embodiments of the present invention has been presented for purposes of illustration and description; however, it is not intended to be exhaustive or to limit the present invention to the precise form disclosed, and modifications and variations are possible as long as they do not deviate from the principles of the present invention.

1. A conductive composition comprising a polar polymer that is used for a constituent material for a conductive member for an electrophotographic apparatus, the composition comprising:
a conductivity imparting agent that comprises quaternary ammonium salt represented by the following formula 1: 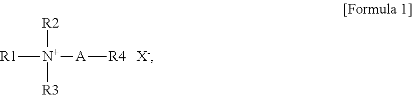
wherein R1 to R3 represent C₁ to C₁₄ alkyl groups, R4 represents one of a methacrylate group and an acrylate group, an anion represented by X⁻ is any one of bistrifluoromethanesulfonimide, triflate, and fluorosulfonylimide, and A represents an alkylene group.

2. The conductive composition according to claim 1, wherein the conductivity imparting agent further comprises metallic salt represented by the following formula 2:
M⁺X⁻, [Formula 2]
wherein the metal represented by M comprises at least one kind of metal selected from the group consisting of sodium, lithium, and potassium, and the anion represented by X⁻ comprises at least one kind selected from the group consisting of bistrifluoromethanesulfonimide, fluorosulfonylimide, and a perchlorate ion.

3. The conductive composition according to claim 2, wherein the polar polymer comprises a urethane foam composition comprising polyol and polyisocyanate.

4. The conductive composition according to claim 2, wherein the polar polymer comprises at least one kind selected from the group consisting of polyurethane rubber, hydrin rubber, acrylonitrile-butadiene rubber, and polyamide.

5. The conductive composition according to claim 1, wherein the polar polymer comprises a urethane foam composition comprising polyol and polyisocyanate.

6. The conductive composition according to claim 1, wherein the polar polymer comprises at least one kind selected from the group consisting of polyurethane rubber, hydrin rubber, acrylonitrile-butadiene rubber, and polyamide.

7. A conductive roll for use in an electrophotographic apparatus, the roll comprising:
a shaft; and
an elastic layer formed on an outer periphery of the shaft,
wherein the elastic layer comprises the conductive composition according to claim 1.

8. A conductive roll for use in an electrophotographic apparatus, the roll comprising:
a shaft;
an elastic layer formed on an outer periphery of the shaft; and
a surface layer formed on an outermost layer of an outer periphery of the elastic layer,
wherein the surface layer comprises the conductive composition according to claim 1.

9. A conductive roll for use in an electrophotographic apparatus, the roll comprising:
a shaft;
an elastic layer formed on an outer periphery of the shaft;
a surface layer formed on an outermost layer of an outer periphery of the elastic layer; and
an intermediate layer between the elastic layer and the surface layer,
wherein the intermediate layer comprises the conductive composition according to claim 1.
